(19) United States
(12) Patent Application Publication
(10) Pub. No.: US 2005/0138441 A1
(43) Pub. Date: Jun. 23, 2005

(54) Power management without interrupt latency

(76) Inventors: Amber D. Huffman, Banks, OR (US); Joseph A. Bennett, Roseville, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/742,705

(22) Filed: Dec. 19, 2003

(51) Int. Cl. G06F 1/26

(52) U.S. Cl. 713/300

(57) ABSTRACT

In some embodiments, a register is to store one or more bits indicating whether a low power mode is to be entered. A controller is to put at least one link in a low power state in response to the one or more bits indicating whether a low power mode is to be entered without waiting for a software interrupt routine when a particular condition occurs (for example, when the link is idle and/or when there are no commands outstanding and no commands to issue on the link). Other embodiments are described and claimed.

### TECHNICAL FIELD

The inventions generally relate to power management without interrupt latency.

### BACKGROUND

Serial ATA is a storage interface technology designed with power issues in mind. Serial ATA is often used as a mobile interface technology, but is not limited to mobile systems. A Serial ATA link can be placed in two low power modes, referred to as “partial” and “slumber”. These low power modes may be entered between commands or even while commands are outstanding in order to save power. The resume time from the partial power managed state is 10 microseconds and the resume time from the slumber power managed state is 10 milliseconds. This allows a system designer to choose a state that balances their power management versus performance needs for a system being designed. Serial ATA also defines registers by which software can explicitly request that the link enter the partial mode or the slumber mode.

The time between a ceasing of communication for a command on a communication link using serial ATA and when software services the corresponding interrupt can be long, and valuable power can be wasted during this interval.

Interrupt latencies on many operating systems (for example, Microsoft operating systems) are extremely variable depending on the load of the system, and can be milliseconds in length. Software cannot place the serial ATA link in a low power managed state until the interrupt service routine is entered. It would be advantageous to have a link (for example, a serial ATA link) be placed in a low power managed state in a faster manner (for example, without any interrupt latency).

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 is a block diagram representation illustrating a system according to some embodiments of the inventions.

FIG. 2 is a block diagram illustrating a control register according to some embodiments of the inventions.

FIG. 3 illustrates a flow diagram according to some embodiments of the inventions.

FIG. 4 illustrates a flow diagram according to some embodiments of the inventions.

### DETAILED DESCRIPTION

Some embodiments of the inventions relate to power management without interrupt latency.

In some embodiments, a register is used to store one or more bits indicating whether a low power mode is to be entered. A controller is to put at least one link in a low power state in response to the one or more bits indicating whether a low power mode is to be entered without waiting for a software interrupt routine when a particular condition is encountered. In some embodiments the condition could be that there are no commands outstanding and no commands to issue (or that the link is idle).

In some embodiments a system includes a host, a host bus adapter (HBA) coupled to the host, at least one device, each of the devices having a corresponding link to couple that device to the host bus adapter, a register to store one or more bits indicating whether a low power mode is to be entered, and a controller to put at least one of the links in a low power state in response to the one or more bits indicating whether a low power mode is to be entered without waiting for a software interrupt routine when a particular condition occurs.

In some embodiments it is determined (for example, by a host bus adapter) whether there are no commands outstanding and no commands to issue on at least one link (the link is idle), and at least one of the links is put in a low power mode without waiting for a software interrupt routine when there are no outstanding commands or commands to issue on link (or links).

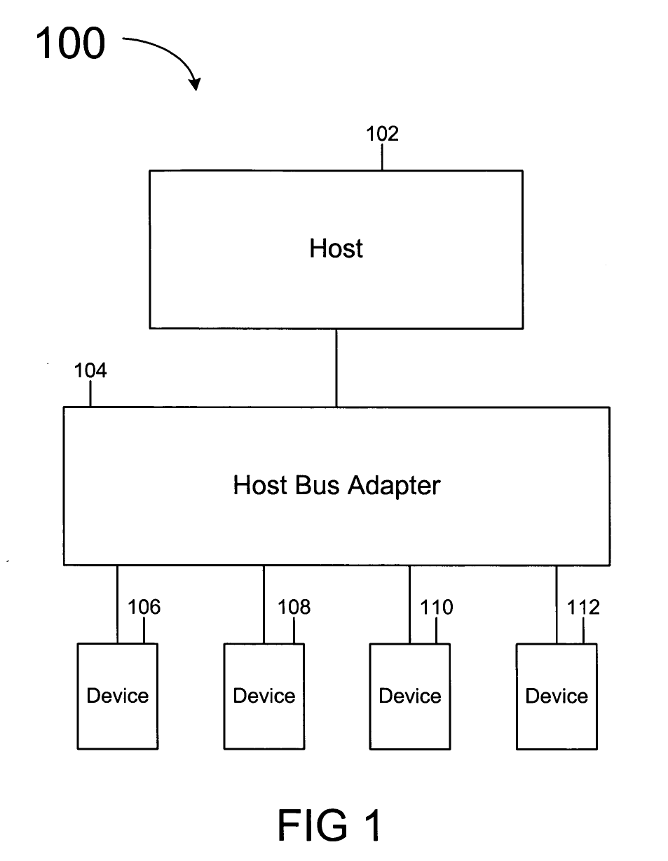

FIG. 1 illustrates a system 100 according to some embodiments. System 100 includes a host 102, a host bus adapter (HBA) 104, and one or more devices 106, 108, 110 and 112. Although four devices are shown in FIG. 1 any number of one or more devices may be used according to some embodiments. Host 102 may be a processor, a controller, a host processor, a host controller, etc. The host bus adapter 104 may be implemented, for example, as an add-in card such as a PCI add-in card, as a part of a chip set and/or connected to the host using any type of bus (for example, PCI, PCI express, etc.) Each of the one or more devices 106, 108, 110 and 112 may be any one or more of a hard disk drive, a tape drive, a CD drive, a CD-ROM drive, a CD-RW drive, a DVD-ROM drive, a DVD-RAM drive, a DVD−R drive, a DVD+R drive, a DVD-RW drive, etc. In some embodiments each of the devices 106, 108, 110 and 112 are storage devices. The devices may all be the same, may all be different, or any combination of devices. The host bus adapter 104 may be connected to the devices 106, 108, 110 and 112 using any type of interface (for example, Serial ATA, Serial Attached SCSI, any serial type interface, any point-to-point interface, any storage interface etc.)

In some embodiments the host bus adapter 104 is allowed to enter a power managed state automatically when there are no commands outstanding. A storage driver can specify via a host controller interface whether a power managed state should be entered automatically, and if so, it can specify which power managed state to enter. Additionally, in some embodiments, the storage driver can specify the power managed state on a per device basis (for example, in a system using point-to-point link technology such as Serial ATA and/or Serial Attached SCSI). In some embodiments a link (for example, a Serial ATA link) can be placed immediately into a low power state without waiting for any interrupt latency overhead.

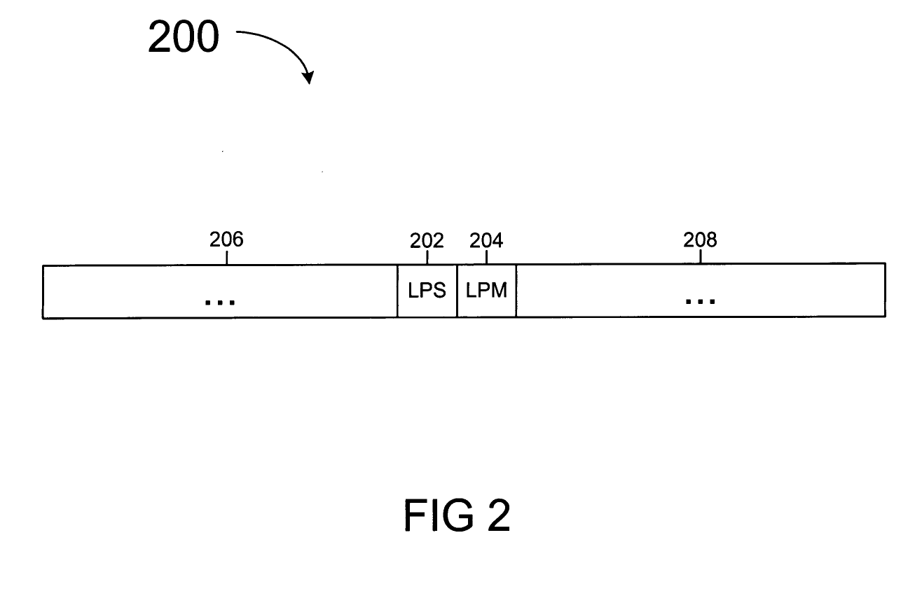

FIG. 2 illustrates a block diagram of a control register 200 according to some embodiments. In some embodiments register 200 is located in a host bus adapter such as the host bus adapter 104 of FIG. 1. In some embodiments register 200 is located in a host such as the host 102 of FIG. 1 and/or a host bus adapter such as the host bus adapter 104 of FIG. 1. In some embodiments a register such as register 200 is associated with each port of an host bus adapter coupled to a device via a link (for example, using Serial ATA). In some embodiments register 200 is a global control register for all links coupled to a host bus adapter. In some embodiments each device (such as device 106, 108, 110 and 112 of FIG. 1) has an associated link and an associated register such as register 200. Register 200 stores a low power link state (LPS) bit or bits 202, a low power link mode (LPM) bit or bits 204, and other portions 206 and 208 that store data and/or information such as address of the device on the link, other status information, and/or control bits. For example, register 200 can contain the speed at which the link is operating and/or the current power management level of the link.

In some embodiments the LPS bit or bits 202 identify two or more low power link states (for example, two states of “partial” and “slumber”, three states, or four states, etc.) In some embodiments the LPM bit or bits 204 identify an input as to whether or not a low power state should be entered by a link in certain circumstances. The LPM bit or bits may be input by a user through software, in response to a selection by software such as whether the system is being run on AC power or a battery, a hardware jumper, or some other means of inputting.

In some embodiments the low power link mode (LPM) bit or bits 204 is one bit. If the LPM bit is, for example, set to “1”, then the host bus adapter (for example, host bus adapter 104 of FIG. 1 or some other HBA) will automatically enter a low power link state when there are no commands outstanding and no commands to issue. The state entered depends on the LPS bit or bits. If the LPM bit is, for example, cleared to “0”, then the host bus adapter will not automatically enter a low power link state (for example, when there are no commands outstanding, or any other time).

In some embodiments the low power link state (LPS) bit or bits 202 is one bit. If the LPS bit is, for example, set to “1”, the host bus adapter will enter a slumber mode (for example, a low power slumber mode such as a Serial ATA slumber mode) when there are no commands outstanding and the LPM bit is set, for example, to “1”. If the LPS bit is, for example, cleared to “0”, then the host bus adapter will enter a partial mode (for example, a low power partial mode such as a Serial ATA partial mode) when there are no commands outstanding and the LPM bit is set, for example, to “1”.

In some embodiments the LPM bit 204 is set to “1” if the system is connected to battery power and is cleared to “0” if the system is connected to AC power such that the HBA enters a low power link state when there are no commands outstanding and no commands to issue, and the system is connected to battery power. In some embodiments operations performed on the LPS bit or bits 202 and on the LPM bit or bits 204 such as those described herein are implemented by a controller (for example, a hardware controller) that is coupled to the register 200. In some embodiments the controller is in a host bust adapter such as host bus adapter 104 of FIG. 1. In some embodiments the controller is in another place other than a host bus adapter (for example in a host such as host 102 of FIG. 1).Although some embodiments have been described herein using two low power states (for example, “partial” and “slumber”, any number of low power states may be used according to some embodiments.

In some embodiments the HBA will automatically enter the low power link states as described in some embodiments described above for all links to the HBA. In some embodiments the HBA will automatically enter the low power link states as described in some embodiments described above on a link-by-link basis. For example, in some embodiments the configuration can be managed on a per device basis automatically (for example, in a mobile system or any other type of system). If the system was set for higher performance, for example, a disk drive device could be set up in a “partial” mode while lower performing devices (for example, a CD device such as a CD-ROM or a DVD device such as a DVD-ROM) could be placed in “slumber” since the slower performance of the lower performing devices could not be discerned. In some embodiment each type of device that is in the system or could possibly be in the system could have a specially designed mode specially suited for that device (for example, a special mode for each of a tape device, a hard disk drive device, a CD device, etc.)

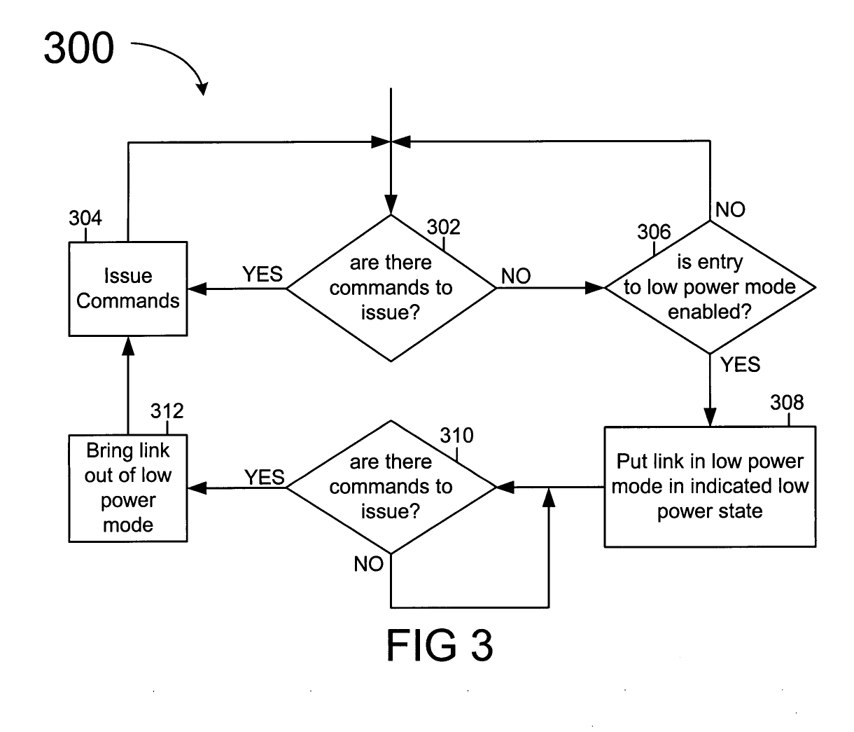

FIG. 3 illustrates a flow diagram 300 according to some embodiments. In some embodiments flow 300 is implemented when a low power mode indication (for example, the LPM bit or bits 204 of FIG. 2) and a low power state indication (for example, the LPS bit or bits 202 of FIG. 2) have already been set. At 302 a decision is made as to whether there are any outstanding commands or any commands to issue (for example, is the link idle?). If it is determined at 302 that there are commands outstanding or commands to issue then control flows to 304. At 304 the commands are issued and/or processed, and flow returns ti 302. If there are no commands to issue at 302 then a determination is made at 304 as to whether entry to a low power mode is enabled. If 304 determines that a low power mode is not enabled then flow returns to 302. If 304 determines that a low power mode is enabled then the link is put into a low power mode in an indicated low power state at 308 (for example, a “partial” or “slumber” mode). In some embodiments the low power state in which the link is placed at 308 may be indicated by the LPS bit or bits 202 of FIG. 2. Then a determination is made at 310 as to whether there are any commands outstanding or any commands to issue (that is, is the link idle?). If there are no commands outstanding or commands to issue at 310 then flow remains at 310 until there are commands outstanding or commands to issue (that is, until the link is no longer idle). Once there are commands outstanding or commands to issue at 310 then the link is brought out of the low power mode at 312 and the commands are issued and/or processed at 304, and flow then returns to 302.

In some embodiments the flow 300 illustrated in and described in reference to FIG. 3 is performed on a link-by-link basis (for example, a different flow 300 for each link). In some embodiments the flow 300 illustrated in and described in reference to FIG. 3 is performed in one flow 300 for all links coupled to an HBA. In some embodiments flow 300 may be performed on a link-by-link basis while using one overall control register. In such embodiments all links may be places in the same low power state (for example, all links in “partial” or all links in “slumber”) when there are not commands outstanding and no commands to issue. However, determination on when to place a particular link in the low power state could be implemented on a link-by-link basis.

In some embodiments the amount of power saved by a link is not solely determined by having a good driver. Setting the bits (for example, the LPS and LPM bits) to control the HBA operation according to some embodiments is a trivial matter. Having software manage the low power states, on the other hand, adds software overhead, makes things more difficult to manage, and incurs latency penalties related to when the software can actually enter the low power modes and/or low power states. Many currently available drivers are poorly written and may not put the link in a low power mode (or to sleep) immediately. Alternatively, some drivers may choose not to put the link in a low power mode (or to sleep) at all (for example, because it is “extra code”). However, in some embodiments the driver only needs to set up the host bus adapter in the appropriate configuration by setting two bits (or two sets of bits LPM and LPS). After that point the HBA will automatically put the link in a low power mode (or to sleep) and automatically bring the link out of the low power state when there are no commands to issue.

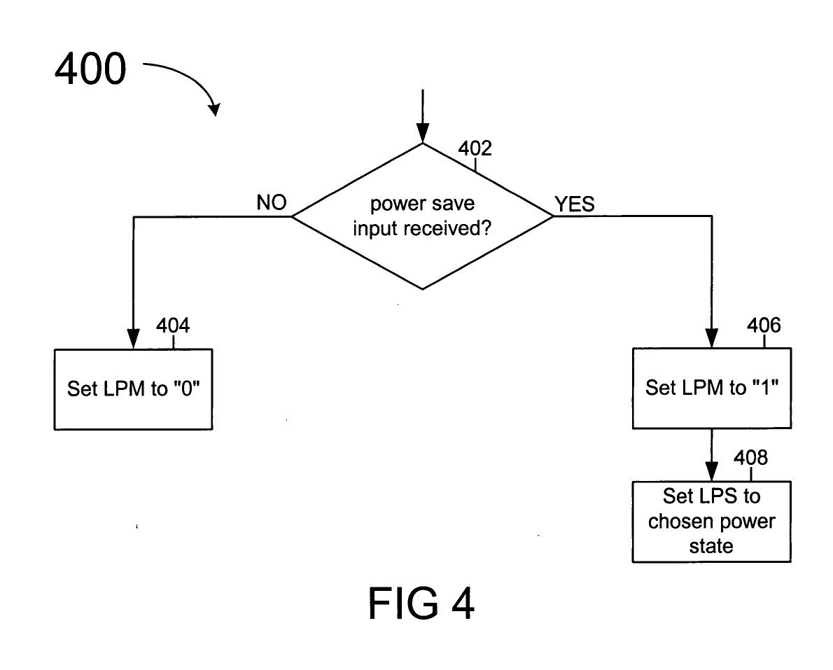

FIG. 4 illustrates a flow diagram 400 according to some embodiments. In some embodiments flow 400 illustrates a driver initialization for a driver of a host bus adapter. At 402 a decision is made as to whether a power save input has been received. In some embodiments the power save input may be an input from a user (for example, via software or via a hardware jumper), or a system indication to save power (for example, a laptop computer or desktop computer where the power save input is provided when the computer is using battery power and not provided when the computer is using AC power, for example). If a determination is made at 402 that no power save input has been received then the LPM bit is set to “0” at 404 (or any other bit or bits or indication is set so that the HBA will not go to a low power mode when there are no commands to be issued, for example). If a determination is made at 402 that a power save input has been received then the LPM bit is set to “1” at 406 (or any other bit or bits or indication is set so that the HBA will go to a low power mode when no commands are to be issued, for example). After the LPM bit is set to “1” at 406 then the LPS is set to a chosen low power state at 408 (for example, a “slumber” mode or a “partial” mode using one bit which can be “0” or “1”, four different modes using two bits, etc.). In some embodiments the low power state chosen at 408 may be chosen by a user of the system or in some other manner (for example, based on the types of devices coupled to the system via the links, etc.)

Pseudo-code for a driver initialization according to some embodiments is as follows:

```
If (save_power)
{
    set LPM to 1;
    if (power_mode_slumber)
    {
        set LPS to 1;
    }
    else
    {
        set LPS to 0;
    }
}
```

In some embodiments power savings may be implemented in any system. In some embodiments power savings may be implemented in any mobile system. In some embodiments battery life may be extended in a system using extra power savings (for example, in a mobile system).

In some embodiments an overhead incurred while waiting for software to initiate a lower power mode for a link may be eliminated. In some embodiments an overhead incurred while waiting for software to initiate a lower power mode for a link may be eliminated while still maintaining software control over what low power states may be entered in order to satisfy performance vs. power considerations.

Although most of the embodiments described above have been described in reference to particular implementations such as the invention being described in several places as having two low power link states (for example, “slumber” and “partial states), other implementations are possible according to some embodiments.

For example, the implementations described herein may be used to implement more than two low power link states or only one low power link state according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

1. An apparatus comprising:
a register to store one or more bits indicating whether a low power mode is to be entered; and
a controller to put a link in a low power state in response to the one or more bits indicating whether a low power mode is to be entered without waiting for a software interrupt routine when a particular condition occurs.

2. The apparatus according to claim 1, wherein the particular condition is that the link is idle.

3. The apparatus according to claim 1, wherein the particular condition is that there are no commands outstanding on the link and there are no commands to issue on the link.

4. The apparatus according to claim 1, the register further to store one or more bits indicating a low power state that is to be entered, the controller to put the link in the low power state in response to the one or more bits indicating the low power state that is to be entered without waiting for the software interrupt routine.

5. The apparatus according to claim 1, wherein the link is a single link and the link that is put in a low power mode is the same single link.

6. The apparatus according to claim 1, wherein the link is a plurality of links and all of the plurality of links are put in the low power mode.

7. The apparatus according to claim 1, the controller further to put the link in a low power state without waiting for the software interrupt routine.

8. The apparatus according to claim 1, wherein the link is a Serial ATA link.

9. The apparatus according to claim 1, wherein the one or more bits indicates that a low power mode is to be entered when the apparatus is running on battery power.

10. A system comprising:
a host;
a host bus adapter coupled to the host; and
at least one device, each of the devices having a corresponding link to couple that device to the host bus adapter;
a register to store one or more bits indicating whether a low power mode is to be entered; and
a controller to put at least one of the links in a low power state in response to the one or more bits indicating whether a low power mode is to be entered without waiting for a software interrupt routine when a particular condition occurs.

11. The system according to claim 10, wherein the particular condition is that the link is idle.

12. The apparatus according to claim 10, wherein the particular condition is that there are no commands outstanding on the link and there are no commands to issue on the link.

13. The system according to claim 10, wherein the register and the controller are included in the host bus adapter.

14. The system according to claim 10, wherein each of the at least one devices is at least one of a tape drive, a hard disk drive, a CD drive and a DVD drive.

15. The system according to claim 10, the register further to store one or more bits indicating a low power state that is to be entered, the controller to put the link in the low power state in response to the one or more bits indicating the low power state that is to be entered without waiting for the software interrupt routine.

16. The system according to claim 10, wherein the link is a link coupled to the host bus adapter and the link put in the low power mode is that link.

17. The system according to claim 10, wherein the link is a plurality of links and all of the plurality of links are put in the low power mode.

18. The system according to claim 10, the controller further to determine a low power state in which the link is to be put when it is put into the low power mode, and to put the link in the low power state in response to the determining of the low power state without waiting for the software interrupt routine.

19. The system according to claim 10, wherein the link is a Serial ATA link.

20. The system according to claim 10, wherein the link is a plurality of links, each of the links having a corresponding register to store one or more bits indicating whether a low power mode is to be entered for that link, and a controller to put that link in a low power state in response to the one or more bits indicating whether a low power mode is to be entered without waiting for a software interrupt routine when a particular condition occurs.

21. The system according to claim 20, each of the registers further to store one or more bits indicating a low power state that is to be entered by that link, each of the controllers to put that link in the low power state in response to the one or more bits indicating the low power state that is to be entered without waiting for the software interrupt routine.

22. The system according to claim 10, wherein the one or more bits indicates that a low power mode is to be entered when the system is running on battery power.

23. A method comprising:
determining whether there are no commands to issue on at least one link; and
when a particular condition occurs, putting at least one of the at least one link in a low power mode without waiting for a software interrupt routine when it is determined that there are no commands to issue on the at least one link.

24. The method according to claim 23, wherein the particular condition is that the link is idle.

25. The method according to claim 23, wherein the particular condition is that there are no commands outstanding on the link and there are no commands to issue on the link.

26. The method according to claim 23, wherein the link is a single link and the link that is put in a low power mode is the same single link.

27. The method according to claim 23, wherein the link is a plurality of links and all of the plurality of links are put in the low power mode.

28. The method according to claim 23, further comprising determining a low power state in which the link is to be put and putting the link in the low power state in response to the determining of the low power state without waiting for the software interrupt routine when a particular condition occurs.

29. The method according to claim 23, wherein the link is a Serial ATA link.

30. The method according to claim 23, wherein the link is a plurality of links, and further comprising determining separately for each of the links a low power state in which that link is to be put and putting that link in the low power state in response to the separate determining of the low power state without waiting for the software interrupt routine when a particular condition occurs.

31. The method according to claim 23, wherein the link is a plurality of links, and wherein the determining and the putting is performed separately for each of the links.

32. The method according to claim 23, wherein the link is put into a low power mode when running on battery power.
